(19) United States
(12) Patent Application Publication
(10) Pub. No.: US 2008/0000887 A1
(43) Pub. Date: Jan. 3, 2008

(54) Method of laser honing

(75) Inventors: Sanjay C. Sheth, Saratoga, CA (US); James S. Lee, San Jose, CA (US)

Correspondence Address: Seagate Technology;c/o DARBY & DARBY P.C., P.O. Box 770, Church Street Station, New York, NY, 10008-0770, US

(73) Assignee: SEAGATE TECHNOLOGY LLC, Scotts Valley, CA (US)

(21) Appl. No.: 11/476,012

(22) Filed: Jun. 28, 2006

(51) Int. Cl. B23K 26/36

(52) U.S. Cl. 219/121.69

(57) ABSTRACT

A method of finishing a surface comprises providing a laser having a pulse shape and energy sufficient to remove asperities from the surface, and directing the laser at grazing incidence to the surface, so that it removes asperities from the surface.

### FIELD OF INVENTION

The present invention relates generally to nano-machining with lasers to improve surface finish and form. This invention relates more specifically to nano-machining of component surfaces in spindle motors.

### BACKGROUND

Magnetic discs with magnetizable media are used for data storage in most all computer systems. Current magnetic hard disc drives operate with the read-write heads only a few nanometers above the disc surface and at rather high speeds, typically a few meters per second.

Generally, the discs are mounted on a spindle that is turned by a spindle motor to pass the surfaces of the discs under the read/write heads. The spindle motor generally includes a shaft fixed to a base plate and a hub, to which the spindle is attached, having a sleeve into which the shaft is inserted. Permanent magnets attached to the hub interact with a stator winding on the base plate to rotate the hub relative to the shaft. In order to facilitate rotation, one or more bearings are usually disposed between the hub and the shaft. An alternate design uses a rotating shaft configuration. Here the sleeve is attached to the base plate.

FIG. 1 shows a schematic of a magnetic disc drive for which a spindle motor having a fluid dynamic bearing manufactured by the method and apparatus of the present invention is particularly useful. Referring to FIG. 1, a disc drive typically includes a housing having a base sealed to a cover by a seal. The disc drive has a spindle to which are attached a number of discs having surfaces covered with a magnetic media (not shown) for magnetically storing information. A spindle motor (not shown in this figure) rotates the discs past read/write heads, which are suspended above surfaces of the discs by a suspension arm assembly. In operation, spindle motor rotates the discs at high speed past the read/write heads while the suspension arm assembly moves and positions the read/write heads over one of a several radially spaced tracks (not shown). This allows the read/write heads to read and write magnetically encoded information to the magnetic media on the surfaces of the discs at selected locations.

As illustrated in FIG. 2, the spindle motor includes a shaft having an outer surface that abuts a sleeve. The shaft rotates relative to the sleeve or vice versa. Shafts can have a variety of shapes, including cylindrical (as shown) and conical.

Over the years, storage density has tended to increase and the size of the storage system has tended to decrease. This trend has lead to greater precision and lower tolerance in the manufacturing and operating of magnetic storage discs. For example, to achieve increased storage densities the read/write heads must be placed increasingly close to the surface of the storage disc. This proximity requires that the disc rotate substantially in a single plane. A slight wobble or run-out in disc rotation can cause the surface of the disc to contact the read/write heads. This is known as a “crash” and can damage the read/write heads and surface of the storage disc resulting in loss of data.

More precise machining can achieve desirably lower tolerances in disc drive manufacture. One area of disc drives particularly suited for laser honing (or finishing) is the spindle motor shaft and sleeve. Traditional material removal processes used in machining disc drives, such as turning or milling, leave machining marks (e.g., peaks and valleys). These machining marks can be due to: (1) cutting tool shape; (2) machining parameters such as feeds, depth of cut, speed, spindle runout, etc.; (3) vibrations induced by the motion of the part and the cutting tool, which can be amplified by structural resonances; and (5) deflection and distortion of the part due to cutting load and thermal changes. Further, electrochemical machining processes are known to leave sulfide inclusions protruding from the machined surface while eroding the surrounding metal, and processes such as grinding cause workpiece variation due to non-uniform yielding of the part and grinding wheel wear.

Honing is used to remove machining marks, thereby improving a machined surface. It is known to use other types of honing such as abrasive grains and rotating tools carrying abrasives such as wires. It is also known to apply lasers directed perpendicular to the workpiece, which can remove machining marks, but are more commonly used to create recesses in the workpiece surface.

### SUMMARY OF THE INVENTION

This invention relates to a method of finishing a surface, comprising providing a laser having a pulse shape and energy sufficient to remove asperities from the surface, and directing the laser at grazing incidence to the surface, so that it removes asperities from the surface. Grazing incidence means substantially tangential to and sometimes just above the surface to be finished if the surface is curved (e.g., a cylinder) or substantially parallel to and sometimes just above the surface to be finished if the surface is flat.

This invention also relates to a method of machining a component of a disk drive, comprising providing a laser having a pulse shape and energy sufficient to remove material from the component, and directing the laser to machine and finish the surface of the component to a desired shape.

This invention further relates to a method of finishing a surface of a workpiece, comprising providing a laser perpendicular to the surface, and focusing the laser onto or adjacent to the surface so that its energy density is sufficient for removing asperities that protrude from a surface without causing an undesirable amount of material to be removed from the surface.

This invention is still further related to a workpiece comprising a finished surface having substantially no machining marks, wherein the machining marks were removed by an ultrafast pulse laser.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 illustrates schematically a magnetic disc drive.

FIG. 2 illustrates a vertical cross section of a spindle motor for a spindle as shown in FIG. 1.

FIG. 3 schematically illustrates an embodiment of laser honing of a cylindrical workpiece in accordance with the present invention.

FIG. 4 schematically illustrates an embodiment of laser honing of a flat surface in accordance with the present invention.

FIG. 5 schematically illustrates another embodiment of laser honing of a cylindrical workpiece in accordance with the present invention.

FIG. 6 schematically illustrates another embodiment of laser honing of a cylindrical workpiece in accordance with the present invention.

FIG. 7 schematically illustrates an embodiment of laser honing of channels in accordance with the present invention.

FIG. 8 schematically illustrates an embodiment of machining a workpiece in accordance with the present invention.

FIGS. 9A-9C schematically illustrate exemplary shapes of pulses used in accordance with the present invention.

FIG. 10 schematically illustrates yet another embodiment of laser honing of a cylindrical workpiece in accordance with the present invention.

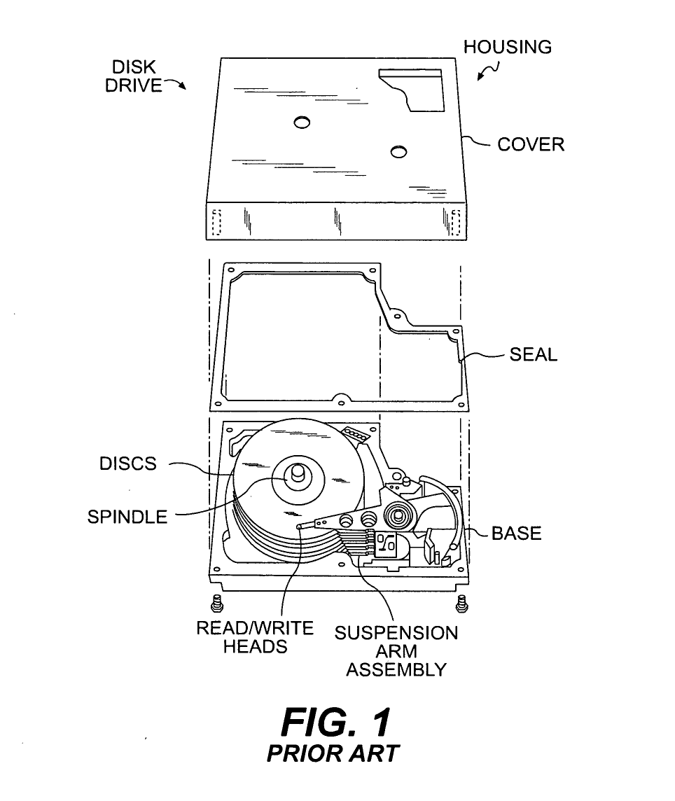

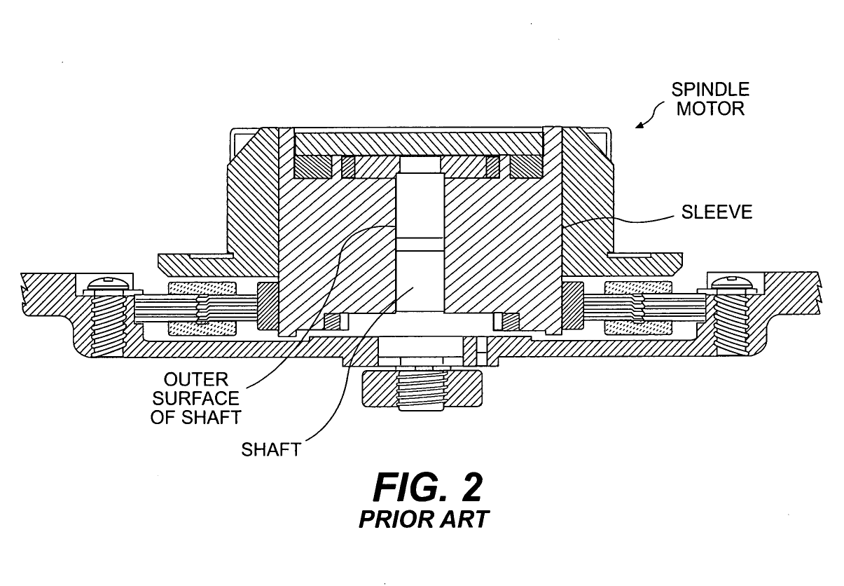

### DETAILED DESCRIPTION

The following description is presented to enable a person of ordinary skill in the art to make and use various aspects and embodiments of the invention. Descriptions of specific materials, techniques, and applications are provided only as examples. Various modifications to the examples described herein will be readily apparent to those skilled in the art, and the general principles defined herein may be applied to other examples and applications without departing from the spirit and scope of the inventions.

The present invention contemplates using a laser to remove machining marks left on the surface of workpieces. The laser is preferably directed incident to the surface of the workpiece, and particularly at a grazing incidence (along the surface of the workpiece). In a preferred embodiment, the laser is an ultra-fast pulse laser, allowing ablation of the machining marks, rather than melting. In a particularly preferred embodiment of the invention, the laser is a femtosecond laser.

Regarding laser types, “ultrafast” means that the laser emits ultra short pulses having a duration that is somewhat less than about 10 picoseconds—usually some fraction of a picosecond. By contrast, a long pulse laser has a pulse that is longer than about 10 picoseconds. The most fundamental feature of material interaction in the long pulse regime is that the heat deposited by the laser in the material diffuses away during the pulse duration. This may be desirable if you are doing laser welding, but for most micromachining jobs, heat diffusion into the surrounding material is undesirable for several reasons. One reason is that heat diffusion from long pulse lasers reduces the accuracy of a micro- or nano-machining operation, because heat diffuses away from the focal spot and melts an area that is much larger than the focal spot. It is therefore difficult to do very fine machining. Another reason is that heat diffusion affects a large zone around the machining spot, causing mechanical stress and creating microcracks (or in some cases macrocracks) in the surrounding material.

Using ultrafast lasers, the heat deposited by the laser into the material does not have time to move away from a work spot within or on the material and accumulates at the level of the work spot, whose temperature rises instantly past the melting point of the material and goes, very quickly, well beyond even the evaporation point. In fact, the temperature continues climbing into what is called the plasma regime.

Femtosecond lasers are ultrafast lasers that deliver a large amount of peak power. Peak power is the instantaneous laser beam power per unit area. These systems routinely deliver 5 to 10 Gigawatts of peak power, and the resulting laser intensity easily reaches the hundreds of Terawatts per square centimeter at the work spot. By ionizing the material being cut—removing it atom by atom—femtosecond lasers allow precise machining of many materials. Each pulse of these lasers is extremely short, lasting just 50 to 1,000 femtoseconds (or quadrillionths of a second). These ultrashort pulses are too brief to transfer heat or shock to the material being cut, which means that cutting, drilling, and machining occur with minimal damage to surrounding material. Ultrafast lasers machine without a melt phase, so that there is no splattering of material onto the surrounding surface.

The present invention contemplates using other types of lasers having a pulse energy sufficient to remove asperities from the surface by ionizing the asperities, and contemplate machining and honing many parts of a spindle motor, for example the spindle shaft 175, using such a laser. Other types of lasers may include, generally, titanium-sapphire lasers, diode-pumped lasers, and fiber lasers.

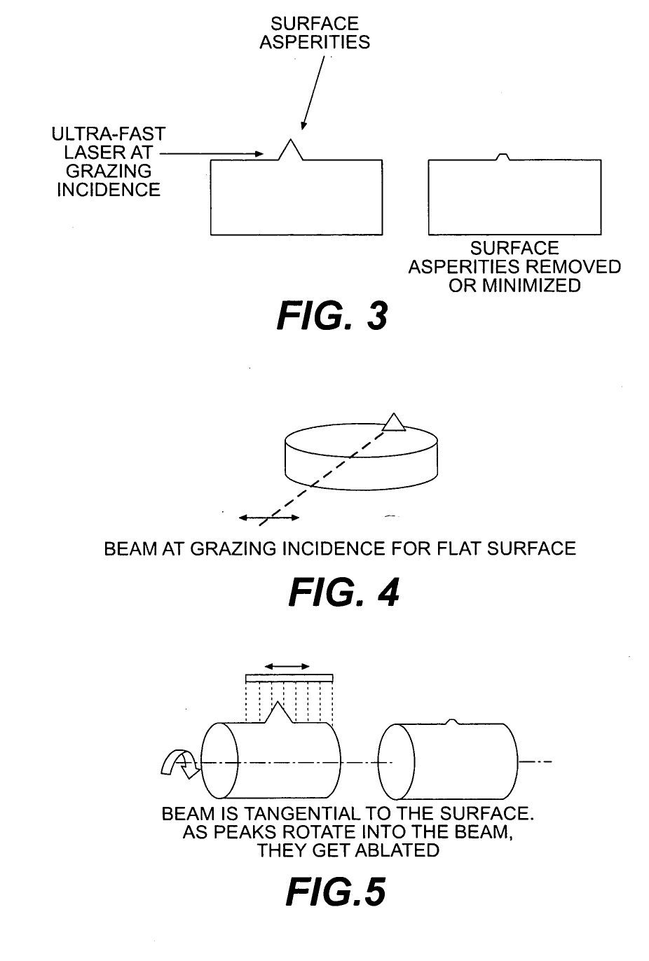

FIG. 3 schematically illustrates honing with an ultrafast laser at grazing incidence to a workpiece, and the resulting removal or minimization of surface asperities on the workpiece. As can be seen, although the laser is incident to the workpiece surface, it is generally perpendicular to the asperity to be removed. To hone a flat surface of a workpiece with a linear laser beam as shown in FIG. 3, the laser can be swept over the surface of the workpiece as illustrated by the arrow in FIG. 4, or the laser can remain stationary and the workpiece can be moved relative to the laser. The present invention also contemplates both the laser and the surface moving.

FIG. 5 schematically illustrates a planar ultrafast laser beam in cross-section, which is directed at grazing incidence to a workpiece. A planar laser beam can remove asperities from a larger surface area of a workpiece. When used with a workpiece having a flat surface, a properly sized laser beam could remove asperities from the workpiece surface without requiring any relative movement of the laser and workpiece. When used with a cylindrical workpiece (such as a spindle shaft) as shown in FIG. 5, the ultrafast laser beam is directed tangential to the cylinder surface to remove asperities. The cylinder is then preferably rotated while the ultrafast laser beam remains incident (tangential) to its surface. The tangential beam can be planar, as shown, or a linear beam.

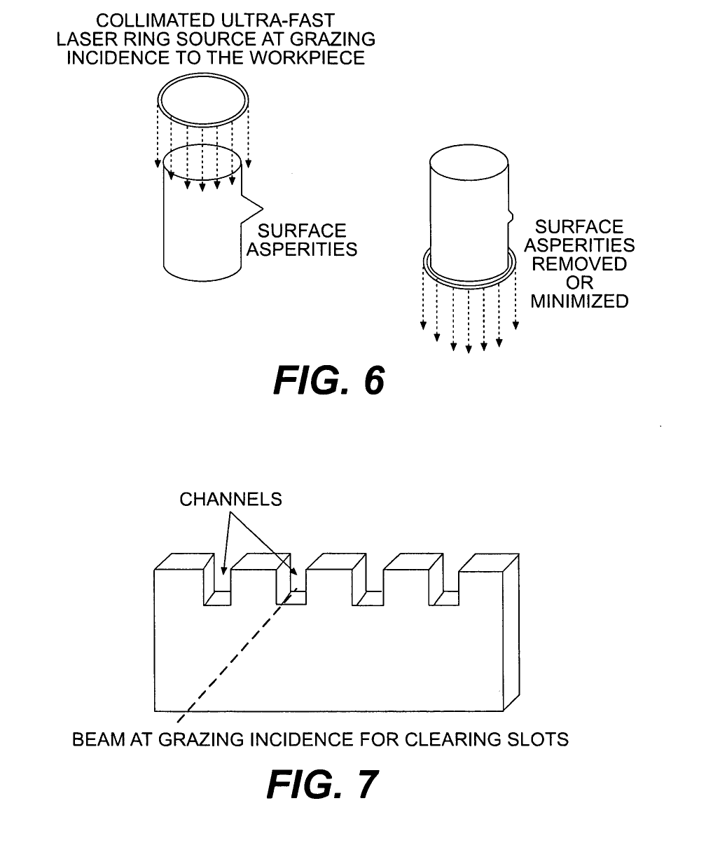

The present invention also contemplates machining a circumference of a workpiece with a complimentary-shaped laser beam. For example, as shown in FIG. 6, a collimated ultrafast laser ring can be directed to surround the perimeter of a cylindrical workpiece.

As illustrated in FIG. 7, an ultrafast pulse laser can additionally be used to clear channels or slots such as those found in electrodes. The beam can be directed at grazing incidence along one or more of the surfaces of each channel.

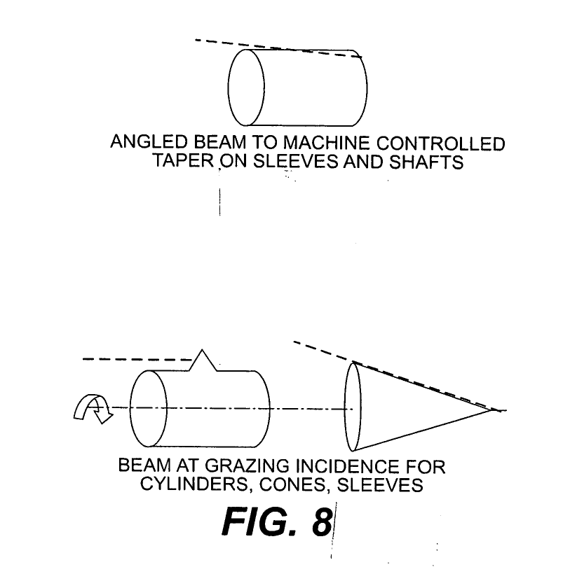

The present invention also contemplates using an ultrafast pulse laser to shape workpieces. For example, as illustrated in FIG. 8, an ultrafast pulse laser can be used to machine a controlled taper on both shafts and their associated sleeves (not shown). Such machining would produce a surface that is substantially free of machining asperities, because it would avoid machining marks caused by known machining processes. In addition, the present invention contemplates using an ultrafast pulse laser to machine matching bearing components in their final assembled state.

Although the above disclosure is directed to honing the surface of a shaft or other male workpiece, the present invention contemplates using an ultrafast pulse laser to hone female workpieces such as sleeves, either as an alternative or in addition to honing of complimentary male workpieces. Thus a shaft and associated sleeve could both be laser honed to provide complimentary surfaces having a decreased number and size of asperities.

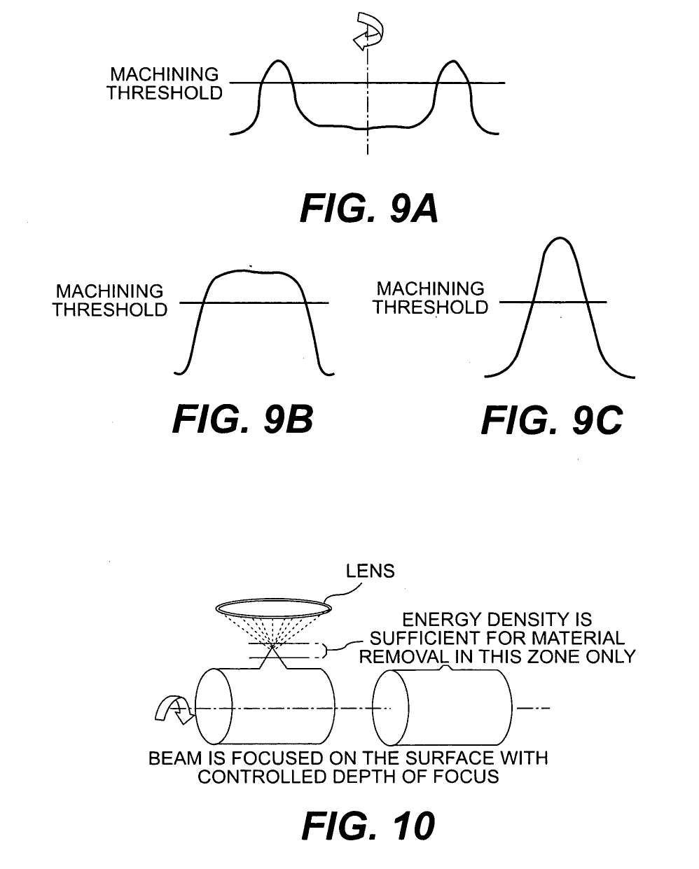

It is known that laser energy is not consistent across its cross section. Thus, ultrafast pulse lasers, such as femtosecond lasers, come in a variety of pulse shapes. Certain pulse shapes can be beneficial to certain applications of laser honing, as discussed below with reference to FIGS. 9A through 9C. In a preferred embodiment of the invention, the portion of the ultrafast pulse laser beam with the appropriate energy to hone the surface to remove asperities is directed at the asperity and does not affect other portions of the workpiece surface.

FIG. 9A illustrates an exemplary cross section of a bi-modal pulse laser beam, the horizontal line denoting the machining threshold of the material to be removed. As can be seen, the bi-modal pulse laser beam has two spaced peaks of energy sufficient to remove asperities from a workpiece surface. The bi-modal pulse laser beam is therefore desirable for machining the circumference of a cylinder. The cylinder's outer surface could be ablated more efficiently, requiring only a half rotation of the cylinder (or the laser). A bi-modal beam could also be used to simultaneously hone opposing sides of a rectangle, or to simultaneously hone two spaced surfaces.

FIG. 9B illustrates an exemplary cross section of a flat-topped pulse laser beam. FIG. 9C illustrates an exemplary cross section of a Gaussian pulse laser beam. The horizontal lines denote the machining threshold of the material to be removed. As can be seen, the wide cross section of the flat-topped beam permits honing of larger asperities, while the finer cross section of the Gaussian beam allows more controlled honing. Due to its ability to permit more controlled honing, the Gaussian beam is particularly preferred for a wide variety of embodiments of the present invention.

FIG. 10 illustrates an alternate embodiment of the invention utilizing a laser directed perpendicular to the workpiece surface, rather than at grazing incidence. As shown, a lens is used to focus the laser beam so that its energy density is sufficient for removing asperities only in a desired area. For example, by focusing the laser beam as shown, the energy density of the beam is sufficient for removing material only in the area that would be affected by a beam directed at grazing incidence. The beam can be focused to remove asperities without removing other material from the surface of the workpiece, or at least without causing an undesirable amount of material to be removed from the surface.

Ultrafast pulse lasers can be used to hone a variety of materials, including a full range of metals and ceramics. The present invention contemplates using more than one laser consecutively or simultaneously.

1. A method of finishing a surface, comprising:
providing a laser having a pulse shape and energy sufficient to remove asperities from the surface; and
directing the laser at grazing incidence to the surface, so that it removes asperities from the surface.

2. The method of claim 1, wherein the ultrafast pulse laser is a femtosecond laser.

3. The method of claim 1, wherein the surface comprises metal or ceramic.

4. The method of claim 1, wherein the surface is the outer surface of a cylinder and the laser grazing incidence is tangential to the outer surface of the cylinder.

5. The method of claim 1, wherein the laser beam is planar.

6. The method of claim 1, wherein the laser moves relative to the surface to remove asperities.

7. The method of claim 1, wherein the surface moves relative to the laser to remove asperities.

8. A method of finishing a surface of a component of a disc drive, comprising:
providing a laser having a pulse shape and energy sufficient to remove material from the component; and
directing the laser to machine and finish the surface of the component to a desired shape.

9. The method of claim 8, wherein the ultrafast pulse laser is a femtosecond laser.

10. The method of claim 8, wherein the component comprises metal or ceramic.

11. The method of claim 8, wherein the laser moves relative to the component to remove asperities.

12. The method of claim 8, wherein the component moves relative to the laser to remove asperities.

13. The method of claim 1, wherein asperities are removed from the surface by ionizing the asperities.

14. The method of claim 13, wherein laser removal of asperities is achieved without a melt phase.

15. A method of finishing a surface of a workpiece, comprising:
providing a laser directed perpendicular to the surface; and
focusing the laser onto or adjacent to the surface so that its energy density is sufficient for removing asperities that protrude from a surface without causing an undesirable amount of material to be removed from the surface.

16. The method of finishing as claimed in claim 15, wherein the laser is an ultrafast pulse laser.

17. The method of finishing as claimed in claim 15, wherein the laser is a femtosecond laser.

18. The method of finishing as claimed in claim 15, wherein the laser is focused with a lens.

19. A workpiece comprising a finished surface having substantially no machining marks, wherein the machining marks were removed by an ultrafast pulse laser.

20. The workpiece of claim 19, wherein laser removal of the machining marks is achieved without a melt phase.
